(19) United States
(12) Patent Application Publication
(10) Pub. No.: US 2004/0255774 A1
(43) Pub. Date: Dec. 23, 2004

(54) Locking mechanism for a linear actuator

(76) Inventor: Ian Hill, Sheeptown (GB)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/821,542

(22) Filed: Apr. 9, 2004

(30) Foreign Application Priority Data
Apr. 11, 2003 (GB) 0308409.2

(51) Int. Cl. F15B 15/26

(52) U.S. Cl. 92/25

(57) ABSTRACT

A locking mechanism for a linear actuator comprising a piston rod arranged for generally linear movement between a fully retracted state and a fully extended state. The locking mechanism comprises a piston follower coupled to the piston rod for movement therewith, and a latching member moveable between a non-locked state and at least one locked state in which the latching member obstructs the movement of the piston follower such that the piston rod is prevented from adopting the fully retracted state.

The present invention relates to linear actuators and in particular to a locking mechanism for use therewith. The invention is particularly, but not exclusively, suited for use with hydraulic linear actuators.

Hydraulic linear actuators are well known and are often referred to as hydraulic cylinders or hydraulic rams. In some applications failure of the actuator or its associated pipework, or accidental operation by an operator can result in personal injury or damaged equipment. Hydraulic check valves can be used to safeguard against pipework failure but such check valves do not protect against a piston, seal or other failure internal to the actuator.

It is known to provide an additional mechanical locking device which may be either manually or automatically operable. If the locking device is manually operated, then its operation relies upon the operator correctly inserting the locking device. A simple prop as used under the raised body of a tipper type lorry is an example of a manually inserted locking device. Automatic locking devices often require extra control devices and actuators and this results in size and cost penalties. An example of an automatic locking device is the ‘scotch’ lever used on vertically stroking hydraulic presses. Whichever conventional approach is adopted, it can be rendered useless by either human error or mechanical/electrical failure.

It is considered therefore that there is a need for an improved locking mechanism for linear actuators.

Accordingly a first aspect of the invention provides a locking mechanism for a linear actuator comprising a piston rod arranged for linear movement between a fully retracted state and a fully extended state, the locking mechanism comprising a piston follower coupled to the piston rod for movement therewith, and a latching member moveable between a non-locked state and at least one locked state in which the latching member obstructs the movement of the piston follower such that the piston rod is prevented from adopting the fully retracted state.

Preferably, the latching member is pivotable with respect to the actuator. Preferably, the latching member is biased to adopt a locked state. For example, a spring, or other biasing means, may be provided between the latching member and the actuator. The latching member may comprise one or more latching bars pivotably mounted on, or coupled to, the actuator. In the illustrated embodiment, the latching member comprises two spaced-apart latching bars, each being pivotably coupled to a respective opposite side of the actuator.

Preferably, the latching member includes one or more bearing surfaces for engagement with the piston follower. Advantageously, the latching member includes a plurality of bearing surfaces, each arranged for engagement with the piston follower, or a respective part thereof, in a respective locked state, wherein the location of each bearing surface in the respective locked state is arranged to halt the movement of the piston rod at a respective state of extension between the fully extended and fully retracted states. In the illustrated embodiment, each latching bar is shaped to define a plurality of respective bearing surfaces.

Preferably, the latching member includes one or more catching surfaces for engagement with the piston follower, as the latching member moves towards the, or a respective locked state, so that the, or a respective, bearing surface is held in the path of the piston follower. In the preferred embodiment, the or each bearing surface is associated with a respective catching surface. Advantageously, the or each bearing surface is substantially perpendicular with its respective catching surface. This may be arranged by providing a respective substantially L-shaped recess in the latching member.

Preferably, the piston follower is arranged for corresponding linear movement with the piston rod. In the preferred embodiment, the piston follower comprises one or more bar, or rod, which is substantially parallel with the piston rod. In the illustrated embodiment, the piston follower comprises two spaced-apart rods located adjacent respective opposite sides of the actuator and arranged for engagement with a respective latching bar. Advantageously, a guide or support member may be provided for guiding the movement of the piston follower (or parts thereof) and provided support thereto (or to parts thereof).

In the preferred embodiment, the locking mechanism further includes one or more secondary actuators arranged to actuate the latching member, or a respective part thereof, from the at least one locked state to the non-locked state. Advantageously, the actuator (main actuator) and the or each secondary actuator are inter-linked so that they may each be operated by a common operating circuit, e.g. hydraulic circuit. Preferably, the common operating circuit is operable in a first mode, in which the piston rod of main actuator is caused to extend, a second mode, in which the piston rod of the main actuator is caused to retract and the respective piston rods of the or each secondary actuator may extend, or a third mode, in which the respective piston rods of both the main and secondary actuators extend.

In the preferred embodiment, the main actuator comprises a double acting actuator having a piston chamber divided into a retract side and an extend side, the retract side being inter-linked with the secondary actuator(s) so that operating fluid may be supplied to the secondary actuator(s) from said retract side to cause the respective piston rods of the secondary actuator(s) to extend. In this arrangement, said third mode of operation is effected by supplying operating fluid, under pressure, to both sides of the main actuator simultaneously.

Other advantageous aspects and features of the invention will be apparent to those ordinarily skilled in the art upon review of the following description of a specific embodiment of the invention and with reference to the accompanying drawings.

Embodiments of the invention are now described by way of example and with reference to the accompanying drawings in which like numerals are used to indicate like parts and in which:

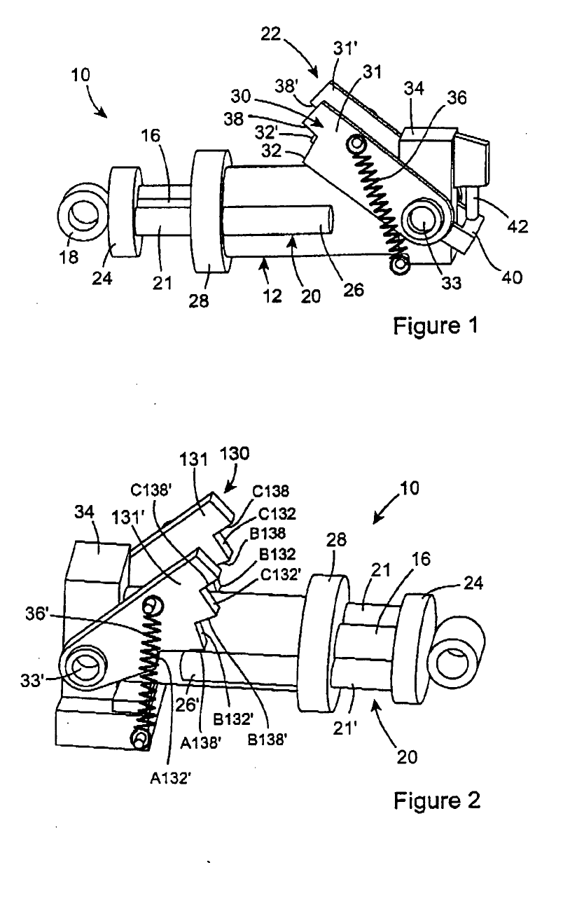

FIG. 1 is a perspective view of a hydraulic linear actuator including a first embodiment of a locking mechanism according to the invention;

FIG. 2 is a perspective view of a hydraulic linear actuator including a second embodiment of a locking mechanism according to the invention;

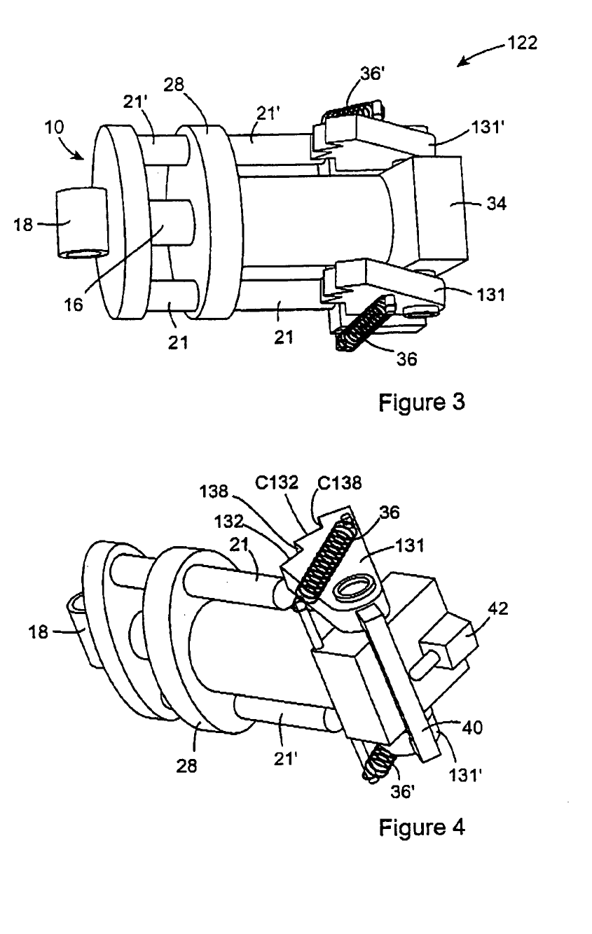

FIG. 3 is an alternative perspective view of the hydraulic linear actuator and locking mechanism of FIG. 2;

FIG. 4 is a perspective view of a hydraulic linear actuator including a third embodiment of a locking mechanism according to the invention;

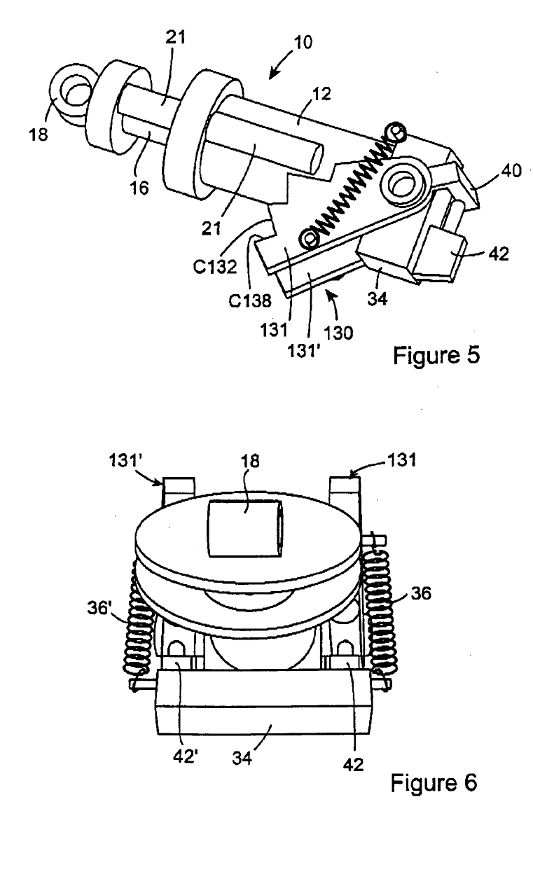

FIG. 5 is an alternative perspective view of the hydraulic linear actuator and locking mechanism of FIG. 4;

FIG. 6 is a further alternative perspective view of the hydraulic linear actuator and locking mechanism shown in FIGS. 2 and 3;

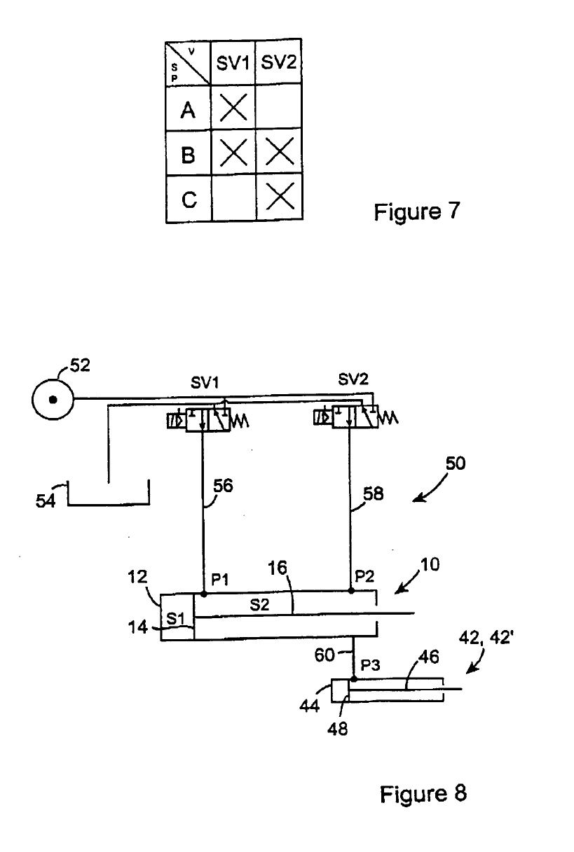

FIG. 7 is a table illustrating the operation of a valve switch suitable for use by the locking mechanisms of FIGS. 1 to 6; and

FIG. 8 is a schematic of a hydraulic circuit suitable for use by the locking mechanisms of FIGS. 1 to 6.

Referring now to FIG. 1 of the drawings, there is shown, generally indicated as 10, a hydraulic linear actuator comprising a piston chamber 12, piston 14 (not visible in FIG. 1 but shown schematically in FIG. 8) and piston rod 16. In the example of FIG. 1, a rod eye 18 is provided at the free external end of the piston rod 18 for connecting the rod 18 to an article (not shown) that requires actuation by the actuator 10. It will be understood that a variety of alternative conventional connectors may be used in place of the rod eye 18.

The actuator 10 is generally conventional in its configuration and operation. The piston rod 16 is generally linearly actuatable between a fully retracted state, in which the piston rod 16 is retracted within the piston chamber 12 to a maximum extent, and a fully extended state in which the piston rod 16 extends from the piston chamber 12 to a maximum extent. In FIG. 1 the piston rod 16 is shown in an intermediate state between the fully extended and fully retracted states. The state of the piston rod 16 is controlled by the flow of hydraulic fluid, usually oil, into and out of the piston chamber 12. For use with the preferred embodiments described hereinafter, the actuator 10 is assumed to be a double-acting actuator in which the state of the piston rod 16 is controlled by the flow of hydraulic fluid into and out of two fluid inlet/outlet ports (not shown in FIG. 1), wherein the piston 14 is located between the two ports.

Hydraulic actuators of the type described above are commonly referred to as hydraulic cylinders (because the piston chamber 12 is usually generally cylindrical as shown in FIG. 1) or hydraulic rams.

FIG. 1 also illustrates a first embodiment of a locking mechanism according to the invention. The locking mechanism is comprised of two main components, namely a piston follower 20 and a latch assembly 22.

The piston follower 20 comprises a rod or bar (or any other suitable member) which is coupled to the piston rod 16 for movement therewith. At least a portion of the piston follower 20 is located externally of the piston chamber 12 so that it may be engaged by the latch assembly 22 as is described in more detail below. In the embodiment of FIG. 1, the piston follower 20 comprises two rods 21, 21′ each of which is connected to, or coupled to, the free end of piston rod 16 so that the rods 21, 21′ are substantially parallel with the piston rod 16. This may be achieved, by way of example, by means of a connecting bar or plate 24 which also, conveniently, may carry the rod eye 18.

When the piston rod 16 moves linearly between the fully retracted and fully extended states, or between any of the infinite number of intermediate states therebetween, the piston follower 20 moves linearly by a corresponding amount in the same direction. Each of the rods 21, 21′ has a respective free end 26, 26′ (only one visible in FIG. 1) located externally of the piston chamber 12 and providing a respective engagement surface for engagement with the latching assembly 22.

Advantageously, a guide or support member may be provided for guiding the movement of the piston follower 20. In FIG. 1, a guide member in the form of a plate 28 is carried by the exterior of the piston chamber 12 and is shaped to define a respective aperture or channel through which the respective rods 21, 21′ pass. The plate 28 helps to reduce flexing or bending of rods 21, 21′ which may occur when under load.

It will be understood that, in alternative embodiments (not illustrated) the piston follower may comprise only one, or more than two, rods or other follower members. The latching assembly 22 comprises one or more latch members 30 comprising at least one respective bearing surface for engagement with the piston follower 20 in order to limit the piston follower's linear travel. In the FIG. 1 embodiment, the latching assembly comprises a latch member 30 having two substantially parallel latching bars 31, 31′ each comprising a respective bearing surface 32, 32′.

The latching bars 31, 31′ are operable between a non-locked state (as shown in FIG. 1) in which the latching bars 31, 31′ do not interfere with the movement of the piston follower 20, and a locked state (shown in FIGS. 2 and 5), in which the latching bars 31, 31′, and in particular the respective bearing surfaces 32, 32′, obstruct the movement of the piston follower 20 thereby preventing the piston rod 16 from reaching its fully retracted state.

Preferably, the latching member 30 is pivotable with respect to the piston chamber 12. In FIG. 1, the latching bars 31, 31′ are pivotably mounted, at respective pivot points 33, 33′, on a butt member 34 located at the base of the piston chamber 12 (i.e. the end of the cylinder opposite that from which the piston rod 16 extends). The latching bars 31, 31′ are therefore pivotable between the non-locked state and the locked state about their respective pivot points 33, 33′. In alternative embodiments (not illustrated), the latching member 30 may be carried directly by the piston chamber 12 or may be carried by an article (not shown), for example a hitch or coupler, into which the actuator 10 is incorporated during use.

In the preferred embodiment, the latching member 30 is biased towards the locked state. In the embodiment of FIG. 1, resilient biasing means in the form of a respective spring 36, 36′ (only one visible in FIG. 1) is provided between each latching bar 31, 31′ and the butt 34 (or any other suitable station) and is arranged to urge the respective latching bar 31, 31′ into the locked state. It will be understood that other conventional biasing means (not illustrated) may alternatively be used for this purpose and that the biasing means need not necessarily be connected to the butt 34 as long as it acts on the latching member 30 in the manner described.

Moreover, in the embodiment of FIG. 1, the latching bars 31, 31′ are joined together by a cross bar 40 such that their movement is unitary. In such an embodiment, there is no need to provide a respective biasing spring, or the like, for each latching bar 31, 31′.

In an alternative embodiment (not illustrated), the latching member is arranged to be urged towards the locked state under the influence of gravity and no biasing is required.

The latching member 30 is arranged so that the latching bars 31, 31′ are disposed at opposite sides of the piston chamber 12 and are arranged for engagement with a respective rod 21, 21′ of the piston follower when in the locked state. Each latching bar 31, 31′ is preferably shaped to define a catching surface 38, 38′ for engaging with the piston follower 20 as the latching member 30 moves into the locked state thereby halting the movement of the latching member 30 so that the respective bearing surface 32, 32′ is located in the path of the respective rod 21, 21′. Preferably, the bearing surface 32, 32′ and its respective catching surface 38, 38′ are substantially perpendicular to one another and are provided by a substantially L-shaped recess formed in the respective latching bar 31, 31′. Alternatively, one or more stop members (not shown) may be provided in the path of the latching member 30 to halt its movement in the manner described above. In use, when the piston rod 16 is in the fully retracted state, the latching member 30 is prevented from adopting the locked state by the piston follower 20 (as is apparent from FIG. 1). As the piston rod 16 is extended towards the fully extended state, the piston follower 20 moves clear of the latching member 30 thereby allowing it to adopt the locked state under the action of the springs 36, 36′. In the locked state, the catching surfaces 38, 38′ engage against the respective rods 21, 21′ thereby positioning the respective bearing surfaces 32, 32′ in the respective path of the free ends 26, 26′ of the respective rods 21, 21′. This may best be appreciated from FIG. 5. Hence the piston rod 16 is prevented from returning to the fully retracted state since the movement of the piston follower 20 is obstructed by the latching member 30, and in particular the bearing surfaces 32, 32′ Hence, in the locked state, the latching member 30 restricts, or limits, the movement of the piston rod 16.

FIGS. 2, 3 and 6 show an alternative embodiment which is generally similar to the embodiment of FIG. 1 and in which like numerals are used to indicate like parts. In FIGS. 2, 3 and 6, the latching bars 131, 131′ are not interconnected and may therefore be operated independently of one another. This means that, should one latching bar 131, 131′ become jammed in, say, the non-locked state, then the other may still adopt the locked state. Further, each latching bar 131, 131′ is advantageously shaped to define more than one bearing surface 132, 132′ and more than one catching surface 138, 138′. This allows the latching mechanism 130 to adopt more than one locked state in which the movement of the piston rod 16 is blocked at respective states of retraction. Preferably, each bearing surface 132, 132′ has a respective associated catching surface 138, 138′ which, advantageously, are substantially perpendicular to one another. In FIGS. 2 and 3, prefixes A and B are used to denote associated bearing and catching surfaces. Associated bearing and catching surfaces 132, 132′, 138, 138′ may be defined by respective substantially L-shaped recesses formed in the respective latching bars 131, 131′. From an alternative viewpoint, the bearing and catching surfaces 132, 132′, 138, 138′ may be formed by providing the latching bars 131, 131′ with a serrated, toothed or stepped edge. The latching bars 31, 31′ of FIG. 1 may be similarly shaped.

Hence, the latching member 130 adopts one of a plurality of locked states in sequence depending on the extension of the piston rod 16. In each progressive locked state, a respective bearing surface 132, 132′ prevents the respective rods 21, 21′ from retracting further than a respective intermediate state, the respective intermediate states being progressively further away from the fully retracted state. Hence, the location of the in use bearing surface 132, 132′ in the path of the rods 20, 20′ varies depending on the extension of the piston rod 16. This restricts the amount by which the piston rod 16 can retract in the event of failure. The amount by which the piston rod 16 can retract in the event of failure is effectively determined by the length of the catching surfaces 138, 138′.

By way of example and with reference to FIG. 2, the latching bar 131′ is shown in a first locked state in which catching surface A138′ engages with the free end 26′ of rod 21′ thereby holding bearing surface A132′ in the path of rod 21′. The travel of rod 21′ in a direction towards the fully retracted state is thus restricted—the piston rod 16 would be prevented from reaching the fully retracted state by engagement of the end 26′ of rod 21′ and the bearing surface A132′As the piston rod 16 extends towards the fully extended state, the end 26′ of rod 21′ moves clear of catching surface A138′. Latching bar 131′ then pivots about pivot point 33′, under the action of spring 36′, until catching surface B138′ engages with rod 21′ thereby holding bearing surface B132′ in the path of rod 21′. Hence, the latching bar 131′ adopts a second locked state (not illustrated) in which the travel of piston rod 16 is further restricted in that, when the end 26′ of rod 21′ engages with bearing surface B132′, the piston rod 16 is held further from the fully retracted state that it is in the first locked state. Similarly, as the piston rod 16 extends still further, the latching bar 131′ adopts a third locked state in which bearing surface C132′ is located in the path of rod 21′. In the third locked state the travel of piston rod 16 is still further restricted in that, when the end 26′ of rod 21′ engages with bearing surface C132′, the piston rod 16 is held still further from the fully retracted state. A similar description applies in relation to the locking bar 131.

It will be seen, therefore, that as the piston rod 16 extends, the location of the in use bearing surfaces 132, 132′ varies between locked states such that the piston 16 is prevented from travelling towards the fully retracted state past a respective intermediate state which is progressively further from the fully retracted state. In the illustrated embodiments, this is achieved by arranging the latching bars 131, 131′ such that the respective distance between the respective bearing surfaces A132, A132′, B132′, B132′, C132, C132′ and pivot point 33′ increases.

Hence, the latching member 30, 130 automatically adopts a locked state as the piston rod 16 extends. In the event of hydraulic or other failure, the travel of the piston rod 16 towards the fully retracted state is restricted by the latching member 30, 130.

In one embodiment (not illustrated) the latching member 30, 130 may be returned to the non-locked state manually. Preferably, however, one or more release actuators, and in particular, hydraulic actuators are provided for this purpose, as is described in more detail below.

In FIG. 1, the latching member 30 is unitary (since latching bars 31, 31′ are mechanically interconnected by cross bar 40) and so one release actuator 42 is provided. The release actuator 42 is arranged to act on the latching member 30, conveniently on cross bar 40, such that extension of the actuator 42 moves the latching member 30 to the non-locked state. The release actuator 42 is preferably a linear hydraulic actuator and may be the same general type as actuator 10, although dual ports are not required.

FIGS. 4 and 5 show an alternative embodiment exhibiting features of both the embodiments of FIG. 1 and of FIGS. 2 and 3. The embodiment of FIGS. 4 and 5 is generally similar to the embodiments already described and similar numerals are used to indicate like parts. In FIGS. 4 and 5, the latching member 130 has a serrated or toothed end similar to that of the FIGS. 2, 3 and 6 embodiment, although the latching bars 131, 131′ are mechanically interconnected by a cross bar 40 similarly to the embodiment of FIG. 1. Hence, a single release actuator 42 may also be used in the embodiment of FIGS. 4 and 5. In the embodiment of FIGS. 2, 3 and 6, a respective release actuator 42, 42′ is provided for each latching bar 131, 131′.

The, or each, hydraulic actuator 42, 42′ is advantageously operable by a hydraulic circuit (not shown in FIGS. 1 to 6) which is integral with the hydraulic circuit (not shown in FIGS. 1 to 6) used to operate the main actuator 10.

A suitable hydraulic circuit 50 for operating the main actuator 10 and the, or each, release actuator 42, 42′ is shown schematically in FIG. 8. The circuit 50 includes a hydraulic fluid (typically oil) source 52 and sink 54. The circuit further includes valve switches SV1, SV2 for controlling the flow of hydraulic fluid to and from the hydraulic actuators 10, 42, 42′.

Hydraulic actuator 10 is shown schematically in FIG. 8 and includes two fluid ports P1, P2 by which hydraulic fluid may flow into and out of the piston chamber 12 via fluid lines 56, 58. The chamber 12 is divided into two sections, S1 (“extend side”) and S2 (“retract side”), by the piston 14. Fluid flow into P1 causes a build up of fluid pressure in section S1 of the chamber 12 and this exerts a force on piston 14 which causes piston rod 16 to extend. As the piston 14 extends, fluid flows out of P2. Similarly, fluid flow into P2 causes a build up of fluid pressure in section S2 of the chamber 12 and this exerts a force on piston 14 which causes piston rod 16 to retract.

A schematic representation of the, or each, release actuator 42, 42′ is also shown in FIG. 8 (only one shown). The actuator 42, 42′ has a fluid port P3 by which hydraulic fluid may flow into and out of the respective piston chamber 44 via fluid line 60. Fluid flow into P3 causes a build up of fluid pressure behind the piston 48 (i.e. on the side of the piston 48 opposite the piston rod 46) and this exerts a force on piston 48 which causes piston rod 46 to extend. Unlike the main actuator 10, actuators 42, 42′ are not (at least in the illustrated embodiment) double acting actuators. Retraction of the piston rod 46 may therefore be effected by any suitable means. For example, after a reduction in fluid pressure behind the piston 48 by an outflow of hydraulic fluid from port P3, piston rod 46 may be retracted under the influence of gravity (depending on the in use orientation of the actuator 42, 42′), and/or under the action of the latching member 30, 130 as it adopts the locked state, and/or under the action of a return mechanism (not shown) such as a spring.

In the preferred embodiment port P3 is fed from, or in fluid communication with, the forward, or retract side (section S2) of chamber 12 (i.e. the side of chamber 12 fed by P2). Hence, a build up of fluid pressure in section S2 of chamber 12 causes fluid to be supplied to chamber 44 via P3. This causes a build up of pressure behind piston 48 which, in turn, causes piston rod 46 to extend. The arrangement is such that before piston rod 16 retracts, or at least before it has retracted enough to cause engagement between the latching bar 30, 130 and piston follower, piston rod 46 is caused to extend by fluid supplied from section S2 into the chamber 44. It will be appreciated that FIG. 8 shows only one instance of the actuator 42, 42′ although in embodiments where more than one actuator 42, 42′ is present, a corresponding description applies for each instance of the actuator 42, 42′.

The respective states of valves SV1, SV2 are controllable by a switch mechanism (not shown) which may adopt one of three switch states. These are illustrated in FIG. 7 as states A, B and C. In state A, SV1 is open to allow fluid to be supplied into piston chamber 12 via port P1. SV2 is closed to prevent fluid from being fed to P2, but allows fluid to flow from P2 and to return to the sink 54. Hence, in switch state A, piston rod 16 extends.

In switch state A, the piston rod 16 extends in normal manner and, as piston rod 16 extends, the latching member 30, 130 will adopt a locking state as described above. When it is desired to retract the piston rod 16, and assuming that no failure has occurred (i.e. that the rods 21, 21′ are not in engagement with the bearing surfaces 32, 32′, 132, 132′), the switch mechanism is operated to cause the valves SV1, SV2 to adopt switch state C.

In switch state C, SV2 is open to allow fluid to be supplied into piston chamber 12 via port P2. SV1 is closed to prevent fluid from being fed to P1, but allows fluid to flow from P1 and to return to the sink 54. Hence, in switch state C, piston rod 16 retracts. Also, because chambers 12, 44 are interconnected, fluid flow into chamber 12 via port 2 results in fluid flow into chamber 44 via port 3. As a result, piston rod 46 extends. The extension of piston rod 46 causes the respective actuator 42, 42′ to move the latching member 30, 130 to the non-locked state. The arrangement is such that, in this normal mode of operation, the, or each, actuator 42, 42′ has moved the latching member 30, 130 into the non-locked state before the piston follower 20 would have otherwise engaged with one or more bearing surfaces 32, 32′, 132, 132′Hence, the latching member 30, 130 is moved to the non-locked state before or during retraction of the piston rod 16 and does not interfere with the retraction of the piston rod 16.

However, should a failure occur such that the piston follower 20 is in engagement with one or more bearing surfaces 32, 32′, 132, 132′, then such engagement prevents, or inhibits, the latching member 30, 130 from moving to the non-locked state in the manner described above. It is therefore preferred to cause the main piston rod 16 to extend slightly to disengage the piston follower 20 from the latching member 30, 130.

In the preferred embodiment, this is achieved by causing the switch mechanism to adopt switch state B. In switch state B, both valves SV1, SV2 are open to allow fluid to be supplied to both sides of piston chamber 12 via both ports P1, P2. Hydraulic fluid is supplied to both sides of piston chamber 12 simultaneously and at substantially the same pressure. This results in a net out-stroke (extension) of piston rod 16 due to differential piston sizes (the force exerted on piston 14 from section S1 will be greater than the force exerted on piston 14 from section S2. This is because the surface area of piston 14 on which fluid in section S2 can act is smaller than the surface area of piston 14 on which fluid in section S1 can act (because of the piston rod 16)). This has the effect of disengaging the piston follower 20 and the latching member 30, 130.

The pressure of fluid supplied to P2 is sufficiently high to ensure that fluid is simultaneously fed to chamber 44 via port 3 and this causes the, or each, piston rod 46 to extend thereby moving the latching member 30, 130 to the non-locked state. The switching mechanism may then be returned to state C to allow the piston rod 16 to be retracted normally.

The provision of switch state B and the corresponding operation of the hydraulic circuit 50 and actuators 10, 42, 42′ is advantageous in that it ensures that the piston follower 20 does not become jammed against the latching bars 31, 31′, 131, 131′ thereby preventing the latch member 30, 130 from being moved to the non-locked state. This can occur as a result of a “race” between the retracting piston rod 16 and the extending piston rod 48: in order to extend the piston rod 48 fluid pressure is normally built up in section S2 of piston chamber 12. However, should the resultant force exerted on piston 14 be tending to retract piston rod 16, sufficient pressure may not be built up until the actuator 10 encounters a stop, which could take the form of engagement between piston follower 20 and the latching bars 31, 31′, 131, 131′.

The switching mechanism may be manually operable or automatically operable as is convenient. In either case, in the preferred embodiment, to disengage the piston follower from the latching member, state B is adopted (typically-for a few seconds) followed by state C to retract the piston rod 16.

It will be appreciated from the foregoing that the locking mechanism described herein provides an automatic locked state which substantially prevents any significant unwanted retraction of the main piston rod 16 as a result of any failure of the main actuator 10. Moreover, the locking mechanism may not readily be moved to the non-locked state through operator error.

A further advantage of the preferred embodiment is that the additional actuator(s) 42, 42′ and associated hydraulic circuitry required to release the latching member 30, 130 do not cause significant penalties in terms of cost and size. The locking mechanism and main actuator 10 may be formed as an integral unit, sharing a common hydraulic circuit (which may be housed in the butt 34 and or chamber 12 body) and requires no additional hydraulic connections or components other than would be required by a conventional hydraulic actuator. Hence the actuator 10 with the locking mechanism of the invention may be used as a direct replacement for conventional actuators.

The invention is described herein in the context of a double acting, dual port hydraulic actuator. It will be understood, however, that at least some aspects of the invention may also be used with non-hydraulic actuators, e.g. spring-biased actuators, or with single port and/or single acting actuators. Further, alternative hydraulic fluid supply arrangements for actuators 10, 42, 42′ other than that depicted in FIG. 8 may be employed.

The invention is not limited to the embodiments described herein which may be modified or varied without departing from the scope of the invention.

1. A locking mechanism for a linear actuator comprising a piston rod arranged for generally linear movement between a fully retracted state and a fully extended state, the locking mechanism comprising a piston follower coupled to the piston rod for movement therewith, and a latching member moveable between a non-locked state and at least one locked state in which the latching member obstructs the movement of the piston follower such that the piston rod is prevented from adopting the fully retracted state.

2. A locking mechanism as claimed in claim 1, wherein the latching member is pivotable with respect to the actuator.

3. A locking mechanism as claimed in claim 1, wherein the latching member is biased to adopt a locked state.

4. A locking mechanism as claimed in claim 1, wherein the latching member includes a plurality of bearing surfaces, each arranged for engagement with the piston follower, or a respective part thereof, in a respective locked state, and wherein the location of each bearing surface in the respective locked state is arranged to halt the movement of the piston rod at a respective state of extension between the fully extended and fully retracted states.

5. A locking mechanism as claimed in claim 1, wherein the latching member includes one or more catching surfaces arranged to engage with the piston follower as the latching member moves towards the, or a respective, locked state so that the, or a respective, bearing surface is held in the path of the piston follower.

6. A locking mechanism as claimed in claim 1, wherein the locking mechanism further includes one or more secondary actuators arranged to actuate the latching member, or a respective part thereof, from the at least one locked state to the non-locked state.

7. A locking mechanism as claimed in claim 6, wherein the linear actuator and the or each secondary actuator are inter-linked so that they may each be operated by a common operating circuit.

8. A locking mechanism as claimed in claim 7, wherein the common operating circuit is operable in a first mode, in which the piston rod of linear actuator is caused to extend, a second mode, in which the piston rod of the linear actuator is caused to retract and the respective piston rods of the or each secondary actuator are caused to extend, or a third mode, in which the respective piston rods of both the linear and secondary actuators extend.

9. A locking mechanism as claimed in claim 6, wherein the linear actuator comprises a double acting actuator having a piston chamber divided into a retract side and an extend side by a piston, the retract side being inter-linked with the, or each, secondary actuator so that operating fluid may be supplied to the, or each, secondary actuator from said retract side to cause the respective piston rods of the, or each, secondary actuator to extend.

10. A locking mechanism as claimed in claim 9 when dependent on claim 8, wherein said third mode of operation is effected by supplying operating fluid, under pressure, to both sides of the linear actuator simultaneously.

11. A linear actuator comprising a piston rod, arranged for generally linear movement between a fully retracted state and a fully extended state, and a locking mechanism as claimed in claim 1.
